(19) United States
(12) Patent Application Publication
(10) Pub. No.: US 2026/0031602 A1
(43) Pub. Date: Jan. 29, 2026

(54) CORRUGATED TUBE HOLDING STRUCTURE AND ELECTRIC WIRE PROTECTION COMPONENT

(71) Applicant: Yazaki Corporation, Tokyo (JP)

(72) Inventors: Kaoru SAWAIRI, Shizuoka (JP); Yoshihito MASUKO, Shizuoka (JP)

(73) Assignee: Yazaki Corporation, Tokyo (JP)

(21) Appl. No.: 19/274,998

(22) Filed: Jul. 21, 2025

(30) Foreign Application Priority Data
Jul. 23, 2024 (JP) 2024-117429

(51) Int. Cl. H02G 3/06; H02G 3/04

(52) U.S. Cl. CPC H02G 3/0691; H02G 3/0468

(57) ABSTRACT

Included is a pair of holding members formed with an accommodation space into which an end of a corrugated tube is inserted in an assembly completion state and which locks movement of the end of the corrugated tube in an insertion direction and a removal direction, in which holding ribs and holding grooves, which are alternately formed in an axial direction, are provided on an inner peripheral surface of the accommodation space, the holding rib is concentrically accommodated in a valley portion of the corrugated tube, and the holding groove concentrically accommodates a peak portion of the corrugated tube.

### CROSS-REFERENCE TO RELATED APPLICATION(S)

The present application claims priority to and incorporates by reference the entire contents of Japanese Patent Application No. 2024-117429 filed in Japan on Jul. 23, 2024.

### BACKGROUND OF THE INVENTION

### 1. Field of the Invention

The present invention relates to a corrugated tube holding structure and an electric wire protection component.

### 2. Description of the Related Art

Conventionally, an electric wire protection component includes a housing and a cover that accommodate a plurality of electric wires drawn out from an end of a corrugated tube having a circular tubular shape and allow the electric wires to be drawn out to the outside. The housing and the cover are provided with holding ribs for holding the end of the corrugated tube from the outer peripheral surface side. Each of the holding rib has a semicircular arc portion that forms an arc portion when the housing and the cover are in an assembly completion state, and holds the end of the corrugated tube by inserting the semicircular arc portion into a valley portion of a bellows portion of the corrugated tube by assembling the housing and the cover (Japanese Patent Application Laid-open No. 2018-164390).

In the conventional corrugated tube holding structure, first, the end of the corrugated tube is installed in the housing while inserting the holding rib on the housing side into the valley portion on the outer peripheral surface side. Subsequently, the corrugated tube holding structure holds the end of the corrugated tube between the housing and the cover by holding the corrugated tube so as not to come off from the housing and assembling the cover to the housing while inserting the holding rib on the cover side into the valley portion on the outer peripheral surface side. As described above, in the conventional corrugated tube holding structure, an assembling process of the housing and the cover and an assembling process of the corrugated tube to the housing and the cover need to be performed at the same time, and thus there is room for improvement in stabilizing the operation of assembling the corrugated tube.

### SUMMARY OF THE INVENTION

Therefore, an object of the present invention is to provide a corrugated tube holding structure and an electric wire protection component capable of improving the assembly workability of a corrugated tube.

A corrugated tube holding structure according to one aspect of the present invention includes a pair of holding members formed with a columnar accommodation space into which an end of a corrugated tube having a circular tubular shape is inserted in an insertion direction along a tube axis in an assembly completion state and which locks movement of the end of the corrugated tube, in the insertion direction, and in a removal direction along a tube axis, wherein the corrugated tube is formed in a bellows tube shape having annular valley portions and peak portions alternately arranged in a tube axial direction, annular holding ribs and holding grooves, which are alternately formed in an axial direction, are provided on an inner peripheral surface of the accommodation space, the holding rib is concentrically accommodated in the valley portion on an outer peripheral surface side, the holding groove concentrically accommodates the peak portion on the outer peripheral surface side, an annular first sidewall surface, which is a sidewall surface on the insertion direction side in the peak portion on the outer peripheral surface side, is formed in a side surface shape of a truncated cone which is tapered toward the insertion direction, an annular second sidewall surface, which is a sidewall surface on the removal direction side in the peak portion on the outer peripheral surface side, is formed in an orthogonal plane shape with respect to the removal direction or a side surface shape of a truncated cone which is tapered toward the insertion direction, an annular first locking surface, which is a sidewall surface on the removal direction side in the holding rib, is an inclined surface having an inclination angle equal to that of the first sidewall surface, and is formed in a side surface shape of a truncated cone which is tapered toward the insertion direction, and an annular second locking surface, which is a sidewall surface on the insertion direction side in the holding rib, is formed in an orthogonal plane shape with respect to the insertion direction.

An electric wire protection component according to another aspect of the present invention includes a corrugated tube having a bellows tube shape, the corrugated tube having annular valley portions and peak portions alternately arranged in a tube axial direction, a plurality of electric wires being inserted therethrough; a housing that accommodates the plurality of electric wires drawn out from an end of the corrugated tube and allows the electric wires to be drawn out to an outside; and a cover that holds the end of the corrugated tube between the cover and the housing in an assembly completion state, and covers and conceals the plurality of electric wires drawn out from the end of the corrugated tube between the cover and the housing in an assembly completion state, wherein the housing and the cover in an assembly completion state are formed with a columnar accommodation space into which the end of the corrugated tube is inserted in an insertion direction along a tube axis and which locks movement of the end of the corrugated tube, in the insertion direction, and a removal direction along a tube axis, annular holding ribs and holding grooves, which are alternately formed in an axial direction, are provided on an inner peripheral surface of the accommodation space, the holding rib is concentrically accommodated in the valley portion on an outer peripheral surface side, the holding groove concentrically accommodates the peak portion on the outer peripheral surface side, an annular first sidewall surface, which is a sidewall surface on the insertion direction side in the peak portion on the outer peripheral surface side, is formed in a side surface shape of a truncated cone which is tapered toward the insertion direction, an annular second sidewall surface, which is a sidewall surface on the removal direction side in the peak portion on the outer peripheral surface side, is formed in an orthogonal plane shape with respect to the removal direction or a side surface shape of a truncated cone which is tapered toward the insertion direction, an annular first locking surface, which is a sidewall surface on the removal direction side in the holding rib, is an inclined surface having an inclination angle equal to that of the first sidewall surface, and is formed in a side surface shape of a truncated cone which is tapered toward the insertion direction, and an annular second locking surface, which is a sidewall surface on the insertion direction side in the holding rib, is formed in an orthogonal plane shape with respect to the insertion direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a corrugated tube holding structure and an electric wire protection component of an embodiment;

FIG. 2 is a perspective view illustrating the corrugated tube holding structure and the electric wire protection component of the embodiment;

FIG. 3 is a cross-sectional view taken along line X-X of FIG. 2;

FIG. 4 is an explanatory view for explaining an assembling process of the corrugated tube;

FIG. 5 is a plan view illustrating a main portion inside a housing; and

FIG. 6 is a plan view illustrating a main portion inside a cover.

### DETAILED DESCRIPTION OF THE PREFERRED EMBODIMENTS

Embodiments of a corrugated tube holding structure and an electric wire protection component according to the present invention will be described in detail below based on the drawings. Note that the present invention is not limited by the embodiments.

### EMBODIMENT

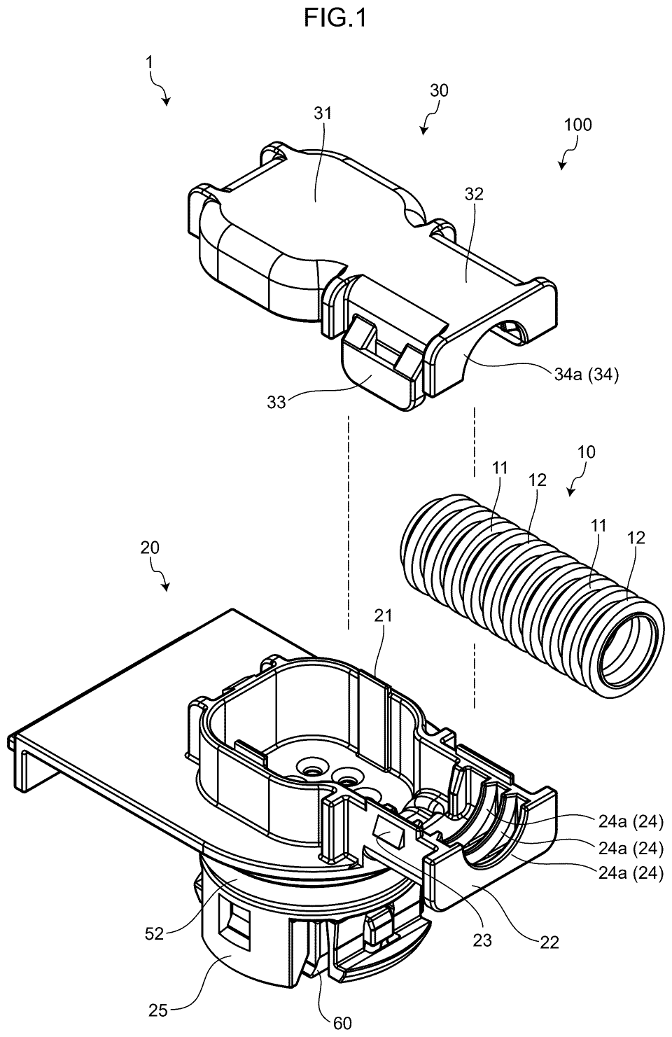

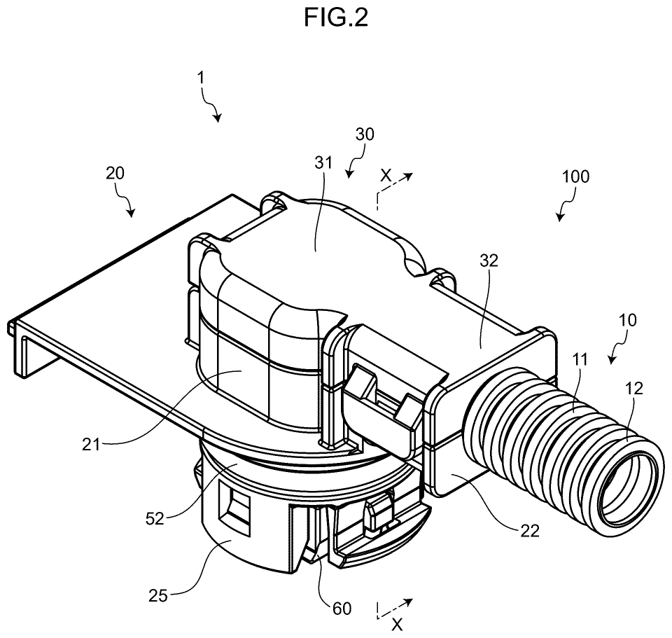

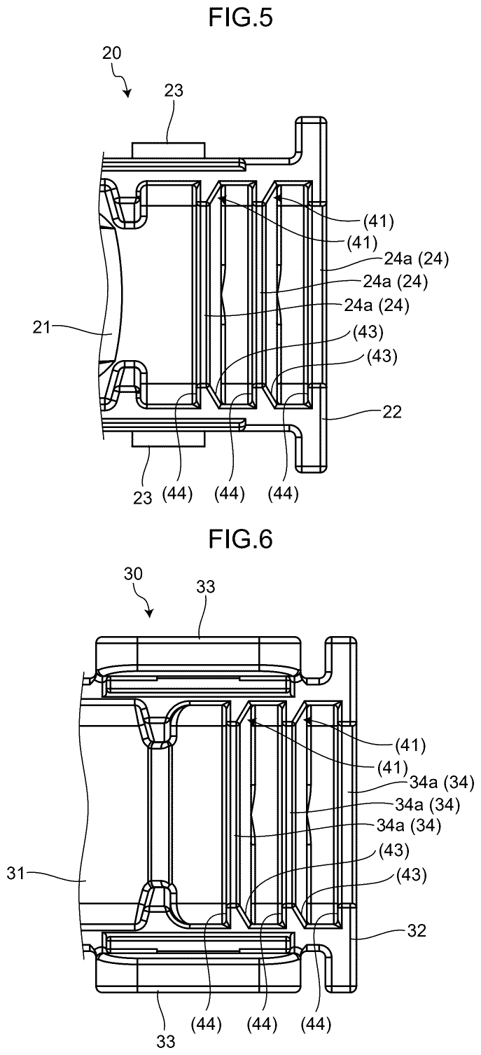

One of the embodiments of the corrugated tube holding structure and the electric wire protection component according to the present invention will be described based on FIGS. 1 to 6.

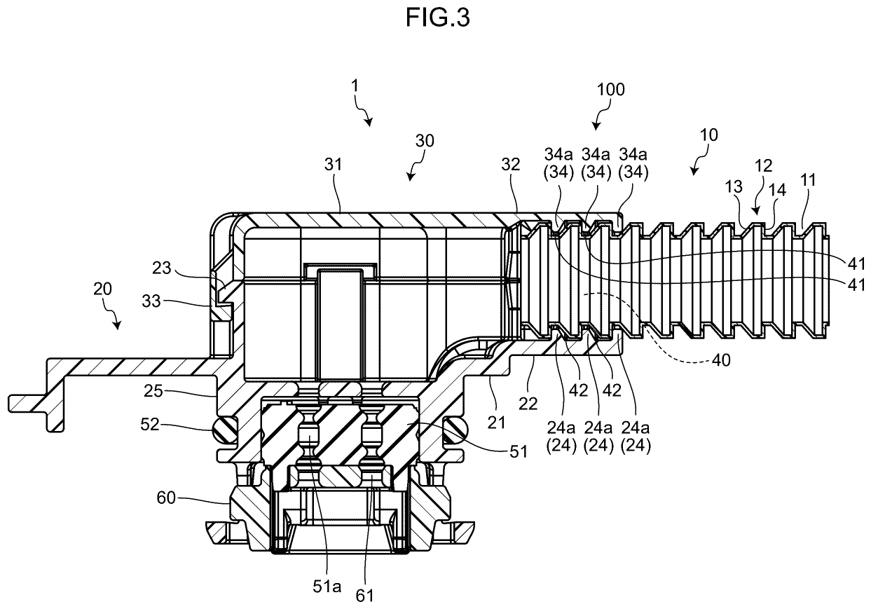

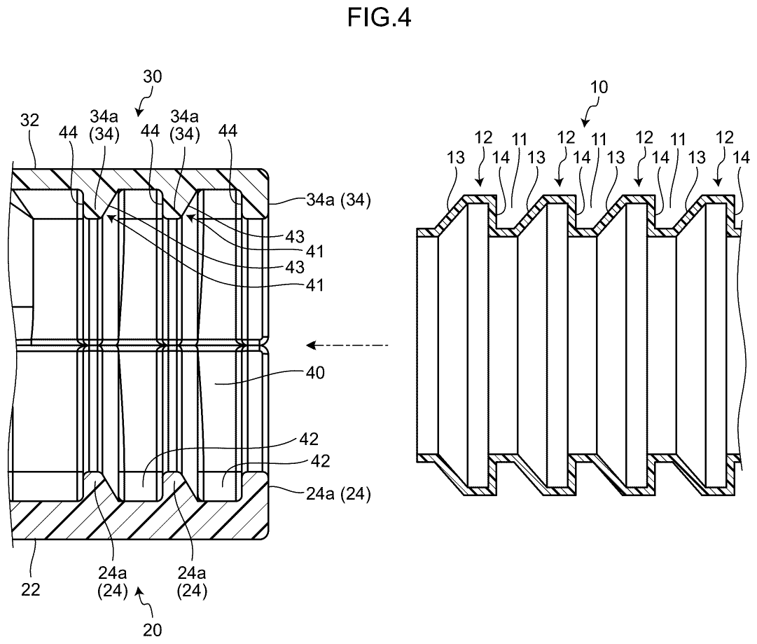

Reference numeral 1 in FIGS. 1 to 3 denotes the electric wire protection component of the present embodiment. The electric wire protection component 1 includes a corrugated tube 10 having a circular tubular shape, and a housing 20 and a cover 30 as a pair of holding members (FIGS. 1 to 3). The housing 20 and the cover 30 as a pair of holding members are formed with a columnar accommodation space 40 into which the end of the corrugated tube 10 is inserted in an insertion direction along a tube axis in an assembly completion state and which locks movement of the end of the corrugated tube 10, in the insertion direction, and in a removal direction along the tube axis (FIGS. 3 and 4). The corrugated tube holding structure 100 of the present embodiment is constituted by the housing 20 and the cover 30.

In the following description, when simply referred to as an insertion direction, the insertion direction indicates an insertion direction of the end of the corrugated tube 10 with respect to the housing 20 and the cover 30 in the assembly completion state. Further, in the following description, when simply referred to as a removal direction, the removal direction indicates a removal direction of the end of the corrugated tube 10 with respect to the housing 20 and the cover 30 in the assembly completion state.

The corrugated tube 10 is formed into a bellows tube shape having annular valley portions 11 and peak portions 12 alternately arranged in a tube axial direction (FIGS. 1 to 4). A plurality of electric wires (not illustrated) is inserted through the corrugated tube 10.

The peak portion 12 on the outer peripheral surface side has an annular first sidewall surface 13 which is a sidewall surface on the insertion direction side, and an annular second sidewall surface 14 which is a sidewall surface on the removal direction side (FIGS. 3 and 4).

The first sidewall surface 13 is also a sidewall surface on the removal direction side in the valley portion 11 on the outer peripheral surface side. The first sidewall surface 13 is formed in a side surface shape of a truncated cone which is tapered toward the insertion direction. The second sidewall surface 14 is also a sidewall surface on the insertion direction side in the valley portion 11 on the outer peripheral surface side. The second sidewall surface 14 is formed in an orthogonal plane shape with respect to the removal direction or a side surface shape of a truncated cone which is tapered toward the insertion direction. The second sidewall surface 14 illustrated here is formed in an orthogonal plane shape with respect to the removal direction. Therefore, the peak portion 12 on the outer peripheral surface side illustrated here is formed in an outer peripheral edge shape of a truncated cone which is tapered toward the insertion direction.

The housing 20 and the cover 30 as a pair of holding members are formed of an insulating material such as a synthetic resin, and are assembled to each other.

The housing 20 accommodates a plurality of electric wires drawn out from an end of the corrugated tube 10 and allows the electric wires to be drawn out to the outside. The cover 30 holds the end of the corrugated tube 10 between the cover and the housing 20 in the assembly completion state, and covers and conceals the plurality of electric wires drawn out from the end of the corrugated tube 10 between the cover and the housing 20 in the assembly completion state.

The housing 20 has a housing body 21 that accommodates a plurality of electric wires drawn out from the end of the corrugated tube 10 (FIGS. 1 to 3). The cover 30 has a cover body 31 that covers and conceals the plurality of electric wires drawn out from the end of the corrugated tube 10 between the cover and the housing 20 in the assembly completion state (FIGS. 1 to 3). The housing body 21 and the cover body 31 form an internal space in which a plurality of electric wires drawn out from the end of the corrugated tube 10 is routed in the assembly completion state.

The housing 20 and the cover 30 respectively have holding portions 22 and 32 that sandwich and hold the end of the corrugated tube 10 from the outer peripheral surface side (FIGS. 1 to 4).

The housing 20 and the cover 30 keep in an assembly completion state between the housing and the cover by a plurality of lock mechanisms. The lock mechanisms keep the assembly completion state by engaging a first engaging portion 23 provided on the housing 20 and a second engaging portion 33 provided on the cover 30 with each other in the assembly completion state (FIGS. 1 and 3). For example, in the lock mechanisms, the first engaging portion 23 is formed as a claw-shaped protruding portion, and the second engaging portion 33 is formed as a portion having a groove-shaped portion to be hooked on the protruding portion. In the lock mechanisms, one of the lock mechanisms is provided between the housing body 21 and the cover body 31, and two of the lock mechanisms are provided between the pair of holding portions 22 and 32.

The accommodation space 40 is formed inside the pair of holding portions 22 and 32 when the housing 20 and the cover 30 are in the assembly completion state. The pair of holding portions 22 and 32 forms a cylindrical shape in the assembly completion state, and holds the end of the corrugated tube 10 in the accommodation space 40 inside the pair of holding portions.

Annular holding ribs 41 and holding grooves 42, which are alternately formed in the axial direction, are provided on the inner peripheral surface of the accommodation space 40 (FIGS. 3 and 4). The holding rib 41 is concentrically accommodated in the valley portion 11 on the outer peripheral surface side. Further, the holding groove 42 concentrically accommodates the peak portion 12 on the outer peripheral surface side.

The pair of holding portions 22 and 32 is a protrusion that protrudes from the respective inner wall surfaces for each of the plurality of valley portions 11 on the outer peripheral surface side of the corrugated tube 10, and has holding ribs 24 and 34 that enter the valley portions 11 to hold the end of the corrugated tube 10 (FIGS. 1 and 3 to 6). The pair of holding ribs 24 and 34 is provided with semicircular arc portions 24a and 34a that are concentrically inserted into the plurality of valley portions 11 on the outer peripheral surface side of the corrugated tube 10 (FIGS. 1 and 3 to 6). The pair of semicircular arc portions 24a and 34a forms an annular portion when the pair of holding portions 22 and 32 is in the assembly completion state, and is concentrically arranged in the valley portion 11. Therefore, in the accommodation space 40, the pair of semicircular arc portions 24a and 34a serves as an annular holding rib 41.

The holding rib 41 has an annular first locking surface 43 which is a sidewall surface on the removal direction side, and an annular second locking surface 44 which is a sidewall surface on the insertion direction side (FIG. 4).

The first locking surface 43 is also a sidewall surface on the insertion direction side in the holding groove 42. The first locking surface 43 is an inclined surface having an inclination angle equal to that of the first sidewall surface 13 of the corrugated tube 10, and is formed in a side surface shape of a truncated cone which is tapered toward the insertion direction. The second locking surface 44 is also a sidewall surface on the removal direction side in the holding groove 42. The second locking surface 44 is formed in an orthogonal plane shape with respect to the insertion direction.

In the electric wire protection component 1, the first sidewall surface 13 on the insertion direction side in the peak portion 12 of the corrugated tube 10 is formed in a side surface shape of a truncated cone which is tapered toward the insertion direction, and the first locking surface 43 on the removal direction side in the holding rib 41 of the accommodation space 40 is formed in a side surface shape of a truncated cone which is tapered toward the insertion direction. The first sidewall surface 13 of the peak portion 12 and the first locking surface 43 of the holding rib 41 have a side surface shape of a truncated cone which is tapered toward the insertion direction, and face each other in a parallel state with the same inclination angle.

In the electric wire protection component 1, since the first sidewall surface 13 of the peak portion 12 and the first locking surface 43 of the holding rib 41 have such a shape and arrangement, the first sidewall surface 13 of the peak portion 12 is locked to the first locking surface 43 of the holding rib 41 when the end of the corrugated tube 10 is about to move in the insertion direction while the peak portion 12 enters the holding groove 42. Therefore, in the electric wire protection component 1, the movement of the end of the corrugated tube 10 in the insertion direction can be locked by the first sidewall surface 13 of the peak portion 12 and the first locking surface 43 of the holding rib 41. Accordingly, in the electric wire protection component 1, the movement of the end of the corrugated tube 10 arranged at the assembly completion position in the accommodation space 40 in the insertion direction can be prevented.

On the other hand, in the electric wire protection component 1, the peak portion 12 which enters the holding groove 42 can be moved into another holding groove 42 located adjacent to the holding groove 42 on the insertion direction side, by applying, to the end of the corrugated tube 10, a load directed toward the insertion direction with a magnitude capable of releasing the locked state between the first sidewall surface 13 of the peak portion 12 and the first locking surface 43 of the holding rib 41. Therefore, in the electric wire protection component 1, the end of the corrugated tube 10 can be inserted to a predetermined position in the accommodation space 40 by inserting the end of the corrugated tube 10 into the accommodation space 40 with such a large load. The predetermined position is an assembly completion position of the end of the corrugated tube 10 in the accommodation space 40.

Further, in the electric wire protection component 1, the second sidewall surface 14 on the removal direction side in the peak portion 12 of the corrugated tube 10 is formed in an orthogonal plane shape with respect to the removal direction or a side surface shape of a truncated cone which is tapered toward the insertion direction (in this example, the second sidewall surface 14 is formed in an orthogonal plane shape), and the second locking surface 44 on the insertion direction side in the holding rib 41 of the accommodation space 40 is formed in an orthogonal plane shape with respect to the insertion direction. Therefore, in the electric wire protection component 1, the second sidewall surface 14 of the peak portion 12 is locked to the second locking surface 44 of the holding rib 41 when the end of the corrugated tube 10 is about to move in the removal direction while the peak portion 12 enters the holding groove 42. Therefore, in the electric wire protection component 1, the movement of the end of the corrugated tube 10 in the removal direction can be locked by the second sidewall surface 14 of the peak portion 12 and the second locking surface 44 of the holding rib 41. Accordingly, in the electric wire protection component 1, the movement of the end of the corrugated tube 10 arranged at the assembly completion position in the accommodation space 40 in the removal direction can be prevented.

As described above, in the electric wire protection component 1, the end of the corrugated tube 10 can be assembled to the assembly completion position of the accommodation space 40 only by pushing the end of the corrugated tube 10 into the accommodation space 40 between the housing 20 and the cover 30 in the assembly completion state. In other words, the electric wire protection component 1 and the corrugated tube holding structure 100 of the present embodiment can improve the assembly workability of the corrugated tube 10. The electric wire protection component 1 and the corrugated tube holding structure 100 of the present embodiment can hold the end of the corrugated tube 10 at the assembly completion position of the accommodation space 40 only by inserting the end of the corrugated tube 10 to the assembly completion position of the accommodation space 40. Accordingly, the electric wire protection component 1 and the corrugated tube holding structure 100 of the present embodiment can ensure the holding force after the assembly of the corrugated tube 10 while improving the assembly workability of the corrugated tube 10.

In the electric wire protection component 1, a plurality of electric wires is drawn out from the corrugated tube 10 in which the end of the corrugated tube is held as described above into the internal space of the housing body 21 and the cover body 31. The housing 20 has an electric wire draw-out portion 25 which allows a plurality of electric wires in an internal space of the housing to be drawn out to the outside (FIGS. 1 to 3). The electric wire draw-out portion 25 is formed in a cylindrical shape whose cylinder axis is orthogonal to a cylinder axis formed by the pair of holding portions 22 and 32.

For example, the plurality of electric wires illustrated here connects a torque sensor of an electric power steering and an electronic control unit. The electric wire protection component 1 is assembled to an enclosure of the torque sensor, and is provided to secure a waterproof function between the enclosure and the electric wire protection component. In the electric wire protection component 1, the electric wire draw-out portion 25 is fitted into a circular through-hole of the enclosure.

Therefore, a columnar mat seal 51 provided with a lip on the outer peripheral surface is accommodated inside the electric wire draw-out portion 25 (FIG. 3). In the mat seal 51, a columnar through-hole (hereinafter referred to as an “electric wire insertion hole”) 51a provided with a lip on the inner peripheral surface is formed for each electric wire (FIG. 3). The electric wire drawn out from the end of the corrugated tube 10 passes through an internal space formed by the housing body 21 and the cover body 31, and is drawn out to the outside through the electric wire insertion hole 51a. As described above, the mat seal 51 is provided to secure a waterproof function inside the electric wire draw-out portion 25.

Note that, in the electric wire protection component 1, the mat seal 51 is prevented from falling off from the electric wire draw-out portion 25 by a mat seal cover 60 assembled to the electric wire draw-out portion 25 (FIGS. 1 to 3). In the mat seal cover 60, an electric wire insertion hole 61 is formed coaxially with the electric wire insertion hole 51a (FIG. 3). The electric wires passed through the electric wire insertion hole 51a of the mat seal 51 are drawn out to the outside through the electric wire insertion hole 61.

Further, an annular seal member 52 is provided on the outer peripheral surface of the electric wire draw-out portion 25 (FIGS. 1 to 3). The seal member 52 fills a gap between the outer peripheral surface of the electric wire draw-out portion 25 and the inner peripheral surface of the through-hole in the enclosure of the torque sensor to secure a waterproof function outside the electric wire draw-out portion 25.

In the corrugated tube holding structure and the electric wire protection component according to the present embodiment, the peak portion which enters the holding groove can be moved into another holding groove located adjacent to the holding groove on the insertion direction side, by applying, to the end of the corrugated tube, a load directed toward the insertion direction with a magnitude capable of releasing the locked state between the first sidewall surface of the peak portion of the corrugated tube and the first locking surface of the holding rib. Therefore, in the corrugated tube holding structure and the electric wire protection component, the end of the corrugated tube can be inserted to an assembly completion position in the accommodation space by inserting the end of the corrugated tube into the accommodation space with such a large load. As described above, in the corrugated tube holding structure and the electric wire protection component, the end of the corrugated tube can be assembled to the assembly completion position of the accommodation space only by pushing the end of the corrugated tube into the accommodation space between the housing and the cover in the assembly completion state. In other words, the corrugated tube holding structure and the electric wire protection component according to the present embodiment can improve the assembly workability of the corrugated tube.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A corrugated tube holding structure comprising:
a pair of holding members formed with a columnar accommodation space into which an end of a corrugated tube having a circular tubular shape is inserted in an insertion direction along a tube axis in an assembly completion state and which locks movement of the end of the corrugated tube, in the insertion direction, and in a removal direction along a tube axis, wherein
the corrugated tube is formed in a bellows tube shape having annular valley portions and peak portions alternately arranged in a tube axial direction,
annular holding ribs and holding grooves, which are alternately formed in an axial direction, are provided on an inner peripheral surface of the accommodation space,
the holding rib is concentrically accommodated in the valley portion on an outer peripheral surface side,
the holding groove concentrically accommodates the peak portion on the outer peripheral surface side,
an annular first sidewall surface, which is a sidewall surface on the insertion direction side in the peak portion on the outer peripheral surface side, is formed in a side surface shape of a truncated cone which is tapered toward the insertion direction,
an annular second sidewall surface, which is a sidewall surface on the removal direction side in the peak portion on the outer peripheral surface side, is formed in an orthogonal plane shape with respect to the removal direction or a side surface shape of a truncated cone which is tapered toward the insertion direction,
an annular first locking surface, which is a sidewall surface on the removal direction side in the holding rib, is an inclined surface having an inclination angle equal to that of the first sidewall surface, and is formed in a side surface shape of a truncated cone which is tapered toward the insertion direction, and
an annular second locking surface, which is a sidewall surface on the insertion direction side in the holding rib, is formed in an orthogonal plane shape with respect to the insertion direction.

2. An electric wire protection component comprising:
a corrugated tube having a bellows tube shape, the corrugated tube having annular valley portions and peak portions alternately arranged in a tube axial direction, a plurality of electric wires being inserted therethrough;
a housing that accommodates the plurality of electric wires drawn out from an end of the corrugated tube and allows the electric wires to be drawn out to an outside; and
a cover that holds the end of the corrugated tube between the cover and the housing in an assembly completion state, and covers and conceals the plurality of electric wires drawn out from the end of the corrugated tube between the cover and the housing in an assembly completion state, wherein
the housing and the cover in an assembly completion state are formed with a columnar accommodation space into which the end of the corrugated tube is inserted in an insertion direction along a tube axis and which locks movement of the end of the corrugated tube, in the insertion direction, and a removal direction along a tube axis,
annular holding ribs and holding grooves, which are alternately formed in an axial direction, are provided on an inner peripheral surface of the accommodation space,
the holding rib is concentrically accommodated in the valley portion on an outer peripheral surface side,
the holding groove concentrically accommodates the peak portion on the outer peripheral surface side,
an annular first sidewall surface, which is a sidewall surface on the insertion direction side in the peak portion on the outer peripheral surface side, is formed in a side surface shape of a truncated cone which is tapered toward the insertion direction,
an annular second sidewall surface, which is a sidewall surface on the removal direction side in the peak portion on the outer peripheral surface side, is formed in an orthogonal plane shape with respect to the removal direction or a side surface shape of a truncated cone which is tapered toward the insertion direction,
an annular first locking surface, which is a sidewall surface on the removal direction side in the holding rib, is an inclined surface having an inclination angle equal to that of the first sidewall surface, and is formed in a side surface shape of a truncated cone which is tapered toward the insertion direction, and
an annular second locking surface, which is a sidewall surface on the insertion direction side in the holding rib, is formed in an orthogonal plane shape with respect to the insertion direction.
